(19) United States
(12) Patent Application Publication
(10) Pub. No.: US 2008/0026832 A1
(43) Pub. Date: Jan. 31, 2008

(54) NETWORKED GAMING SYSTEM

(76) Inventors: Christopher Michael Stevens, Lane Cove (AU); Stephen Byng, Lane Cove (AU)

Correspondence Address: MCANDREWS HELD & MALLOY, LTD, 500 WEST MADISON STREET, SUITE 3400, CHICAGO, IL, 60661, US

(21) Appl. No.: 11/748,974

(22) Filed: May 15, 2007

(30) Foreign Application Priority Data
May 15, 2006 (AU) 2006902578
Dec. 14, 2006 (AU) 2006907005

(51) Int. Cl. G06F 17/00

(52) U.S. Cl. 463/26; 463/42

(57) ABSTRACT

In one form there is disclosed a method of triggering an event in a gaming machine network including a plurality of gaming machines. The method includes defining at least one first level trigger event which can be associated with at least one of the plurality of gaming machines and in the event that a first level trigger event occurs, triggering a first level event in relation to each associated gaming machine. The method also includes defining a second level triggering event which is dependent upon the occurrence of a plurality of first level events, each of the plurality of first level events being associated with one or more of the plurality of gaming machines. In the event that the second level triggering event occurs, triggering the second level event.

### RELATED APPLICATIONS

This application claims priority to an Australian patent application filed on May 15, 2006, as serial number AU2006902578, entitled “Networked Gaming System,” which is herein incorporated by reference in its entirety.

### FIELD OF THE INVENTION

The present invention relates to gaming apparatus and methods of gaming. In particular, the present invention relates to a networked gaming system. It will be convenient to describe embodiments of the present invention in the context of a slot machine having a bonus feature that is triggered by an accumulator mechanism, however the invention should not be construed to be limited to the type of gaming machine, trigger or bonus game disclosed in the present specification.

### BACKGROUND

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming devices and systems have attempted to provide the sought after variety, while still developing games that comply with the relevant regulations in the jurisdiction of the gaming venue operator. Suppliers of gaming devices therefore are faced with restrictions on the types of games and gaming apparatus that are allowable, both in terms of the prevailing regulations and in terms of providing a return on investment to the gaming venue operators.

In addition, it is important that a player be able to understand the operation of a game quickly so that the player promptly feels that they are in control of game play and can therefore extract maximum entertainment from the game.

Casinos and other gaming venues, such as hotels and clubs, can operate hundreds or thousands of gaming machines. The vast majority of these gaming machines will be arranged in an area, e.g. a floor or part of a floor, of the casino (or establishment) that is dedicated to the operation of gaming machines. Machines in such areas may be arranged in groups on the floor by game type, denomination, or theme etc. to increase player interest. Moreover, progressive or linked jackpots and tournament games can also be used to increase player interest, and excitement. As a result of this type of concentration and arrangement of gaming machines, there might be hundreds or thousands of players playing in the same casino, or on the same floor or the casino, at the one time.

In systems offering progressive prizes the progressive prize is contributed to through gaming activity on the gaming machine, for example by taking a percentage of all wagers placed on the gaming machine. The progressive prize is awarded on the occurrence of a progressive prize winning event. Various methods of contribution to a progressive prize and determination of when the progressive prize has been awarded have been developed.

One method of awarding a progressive prize is to monitor play of a game on a gaming machine that is contributing to the progressive prize for the occurrence of a particular outcome, and awarding the progressive prize to that gaming machine. The player can therefore see in his or her game the outcome that resulted in the award of the progressive prize.

Another method of awarding a progressive prize is to award the prize to the gaming machine that causes the progressive prize to reach a certain amount. The certain amount may be randomly determined within a range of values. Using this method and similar methods, the award of the progressive prize is substantially unrelated to the play of a game on the gaming machine, other than the events that cause a contribution to be made to the progressive prize.

A special prize such as a progressive prize may be able to be won by a number of linked gaming machines. In this case, the designer and/or operator of the gaming machines must determine a fair way for each gaming machine to win the special prize. It is an ongoing problem to find new ways of offering special prizes on gaming machines.

Notwithstanding this large number of people together, who are engaged in a common pursuit e.g. attempting to win a progressive prize (or more generally, playing gaming machines), the present inventors have determined that there is typically little, if any, interaction between players, other than talking between players of adjacent gaming machines.

The present inventors have therefore determined that player interest and excitement might be enhanced further if the level of interaction between players can be increased.

In this specification, the term “linked gaming machine” means a gaming machine that is connected in a general sense to another gaming machine through a communication channel and/or one or more devices. Linked gaming machines therefore include networked gaming machines able to communicate with each other and gaming machines able to communicate with a common device, optionally through one or more intermediary devices, irrespective of whether or not the individual gaming machines share any information with each other through the connection.

It is an object of the present invention to provide a gaming system that overcomes or alleviates problems in gaming systems at present, that provides interest or excitement to a player and/or which at least provides the public with a useful choice.

Any reference in this specification to the prior art does not constitute an admission that such prior art was well known or forms part of the common general knowledge in any jurisdiction.

### SUMMARY OF THE INVENTION

In a first aspect the present invention provides a method of triggering an event in an gaming machine network including a plurality of gaming machines, said method including: defining at least one first level trigger event which can be associated with at least one of said plurality of gaming machines; and in the event that a first level trigger event occurs, triggering a first level event in relation to each associated gaming machine; defining a second level triggering event which is dependent upon the occurrence of a plurality of first level events, each of said plurality of first level events being associated with one or more of said plurality of gaming machines; and in the event that said second level triggering event occurs, triggering said second level event.

At least two of the plurality of first level events can be associated with at least one different gaming machine.

The first level trigger event can be selected from the following kinds of event:

an outcome of a base game fulfilling at least one predetermined criterion;

an outcome of a bonus game fulfilling at least one predetermined criterion;

an outcome of a tournament game fulfilling at least one predetermined criterion;

at least one player fulfilling at least one player-related criterion;

a gaming machine fulfilling at least one gaming machine-related criterion;

a node of the network fulfilling at least one predetermined criterion;

an at least partly randomly generated event; and

a jackpot triggering event.

In one embodiment at least two of the first level triggering events on which a second level triggering event is dependent, are achievable on mutually exclusive sets of gaming machines within the plurality of gaming machines.

In another embodiment at least two of the first level triggering events on which a second level triggering event is dependent have different probabilities of occurrence on different gaming machines within the plurality of gaming machines.

The first level event can include, associating or awarding at least one accumulatable token with a gaming machine or player of a gaming machine. Said token is preferably represented in a data form.

The second level event trigger can include, compiling a plurality of accumulatable tokens that fulfil at least one predetermined criterion.

The method can further include, enabling cooperation between players of two or more gaming machines, via the gaming machine network, to cooperate to cause second level triggering event.

In certain embodiment a compilation of accumulatable tokens can include tokens associated with different gaming machines or players by corresponding first level events.

The method can further include triggering a second level event in respect of at least two gaming machines or players. In this case preferably the second level event is triggered in respect of at least two players that have cooperated to cause the second level triggering event, or their associated gaming machines.

The method can include awarding a prize or award associated with said second level event to a plurality of players or gaming machines associated with said second level event.

The method can include awarding a prize or award associated with said second level event to the plurality of players that cooperated to cause the second level triggering event, or their associated gaming machines.

The method can include dividing a prize or award associated with said second level event amongst a plurality of players or gaming machines associated with said second level event.

Preferably the prize or award associated with said second level event is divided amongst a plurality of players that cooperated to cause the second level triggering event, or their associated gaming machines.

Additionally the method can include dividing a prize or award associated with said second level event in a predetermined manner. The prize or award associated with said second level event can be divided evenly amongst the plurality of players or gaming machines. The prize or award associated with said second level event can be divided amongst the plurality of players or gaming machines in proportion to an extent of each player's or gaming machine's contribution to the second level triggering event. The prize or award associated with said second level event can be divided amongst the plurality of players or gaming machines according to a player determined scheme. In other forms the prize or award associated with said second level event could also be divided amongst the plurality of players or gaming machines in proportion to the relative probability of occurrence of each player's contribution to the second level triggering event, or in proportion to an amount wagered by each player.

In a second aspect the present invention provides a gaming machine network including, a plurality of gaming machines, a plurality of first client processes each of which is configured to implement a gaming service associated with a respective gaming machine, a plurality of promotional clients each of which is configured to interact with an associated first client process to detect the occurrence of a first level event in the associated first client process; at least one promotional server process configured to interact with a plurality of promotional clients to determine the occurrence of a second level triggering event whose occurrence is contingent on the previous occurrence of a plurality of first level events; and in the event of a second level triggering event occurring triggering a second level event to be implemented by at least one of said promotional clients.

The second level triggering event determined by the promotional server process can be contingent upon the occurrence of at least one first level event in client processes associated with different gaming machines.

In preferred forms the first client process is selected from the following kinds of process:

a game process;

a bonus process;

a tournament game process;

a jackpot process

a player process

a gaming machine process;

a system process.

The first level event can be triggered by a first level triggering event selected from the following kinds of event:

an outcome of a base game fulfilling at least one predetermined criterion;

an outcome of a bonus game fulfilling at least one predetermined criterion;

an outcome of a tournament game fulfilling at least one predetermined criterion;

at least one player fulfilling at least one player-related criterion;

a gaming machine fulfilling at least one gaming machine-related criterion;

a node of the network fulfilling at least one predetermined criterion;

an at least partly randomly generated event; and

a jackpot triggering event.

The first level event includes the association of at least one accumulatable token with a gaming machine or player of a gaming machine by an associated first client process.

The promotional client process can be configured to compile a plurality of accumulatable tokens associated with a respective gaming machine.

The promotional server process can preferably be configured to interact with a plurality of promotional clients and to compile a plurality of accumulatable tokens associated with different gaming machines, and wherein a second level triggering event is determined to have occurred if the plurality of accumulatable tokens compiled by the promotional server fulfil at least one predetermined criterion.

The network can further include a plurality of player interaction processes configured to enable interaction between a player of a gaming machine associated with a player interaction process and at least one other gaming machine.

Preferably the player interaction process is configured to enable cooperation between players of two or more gaming machines, via the gaming machine network, to cooperate to cause second level triggering event.

A promotional server process can trigger at least one promotional client process to initiate a second level event in respect of a corresponding gaming machine or player.

The promotional server process can trigger two or more promotional client process to initiate a second level event second level in respect of two or more corresponding players that have cooperated to cause the second level triggering event, or their associated gaming machines.

The gaming machine network can be configured to award a prize or award associated with said second level event to a plurality of players or gaming machines associated with said second level event in the event of at least one predetermined outcome.

Preferably the prize or award is given to the plurality of players that cooperated to cause the second level triggering event, or their associated gaming machines, in the event of at least one predetermined outcome.

The network can be configured so as to divide a prize or award associated with said second level event amongst a plurality of players or gaming machines associated with said second level event.

Preferably the prize or award associated with said second level event is divided amongst a plurality of players that cooperated to cause the second level triggering event, or their associated gaming machines.

The promotional client process or promotional server process can be configured to divide a prize or award associated with said second level event in a predetermined manner. The prize or award can be divided evenly amongst the plurality of players or gaming machines. The prize or award can be divided in proportion to an extent of each player's or gaming machine's contribution to the second level triggering event. The prize or award can be divided according to a player determined scheme.

According to another aspect, the invention broadly resides in a method for use with a plurality of linked gaming machines, each gaming machine operable to play at least one game, the method comprising:

identifying a plurality of outcomes resulting from play of at least one game on each of at least two of a plurality of linked gaming machines;

comparing the identified outcomes with a predefined criterion, the predefined criterion being collectively achievable by the plurality of linked gaming machines; and

following satisfaction of the predefined criterion, performing a predetermined action.

The predefined criterion may comprise the occurrence of at least two distinct outcomes, which are achievable on mutually exclusive sets of gaming machines within the plurality of linked gaming machines.

The predefined criterion may comprise the occurrence of at least two outcomes having different probabilities of occurrence on different gaming machines within the plurality of linked gaming machines.

The predetermined action may comprise causing the award of an award at each gaming machine that contributed to the satisfaction of the criterion. The award may be equal for each said gaming machine. Alternatively, the award to each said gaming machine may be determined depending on what aspect of the criterion was satisfied by that gaming machine.

In one embodiment, the predetermined action comprises causing the award of a feature game at each gaming machine that contributed to the satisfaction of the criterion and the possible outcomes of the feature game may comprise outcomes associated with the award of another award at the gaming machine where the feature outcome occurred.

The predefined criterion may comprise the occurrence of a plurality of events that can occur at separate times and may comprise a requirement that the plurality of events must occur within a certain proximity to each other to satisfy the criterion. In one embodiment, the plurality of events must occur within a certain period of time. In another embodiment, the plurality of events must occur within a certain number of game plays. In a still further embodiment, the plurality of events must occur within a certain amount of turnover or coin-in on the linked gaming machines. The predetermined criterion may specify that the events must occur within a proximity dictated by the longest or shortest period defined by a plurality of metrics of proximity.

In one embodiment, if the predefined criterion comprises the occurrence of a plurality of events within a certain proximity to each other and the period defined by the certain proximity lapses from the first of the plurality of events without the predefined criterion having been met, then all of the predefined events that have occurred at the time of the lapsing of the period defined by the certain proximity are disregarded for determining whether the predefined criterion is satisfied after the time of the lapsing of the period defined by the certain proximity. In another embodiment, only the first occurring predefined event is disregarded and the period defined by the certain proximity is redefined with reference to the second occurring predefined event.

The method may comprise comparing the identified outcomes with predefined criteria, wherein said predetermined action comprises a different action depending in which criterion in said criteria has been satisfied. The predefined criteria may have different probabilities of occurrence.

The method may comprise defining the predefined criteria so that one criterion in the predefined criteria can only be satisfied by a defined group of gaming machines within the plurality of linked gaming machines, the defined group of gaming machines comprising at least two and less than all of the plurality of linked gaming machines. The predefined action may comprise awarding a prize and the method may comprise defining the predefined criteria so that each gaming machine in the plurality of gaming machines has an equal probability of winning an equal prize.

An outcome may have to occur in a purchased pay line in a spinning reel game or equivalent outcome delineator in other styles of game before it is eligible to be used to satisfy a criterion.

According to another aspect, the invention broadly resides in a method for use with a plurality of linked gaming machines, each gaming machine operable to play at least one game, the method comprising:

identifying a plurality of outcomes resulting from play of at least one game on each of at least two of a plurality of linked gaming machines;

comparing the identified outcomes with a predefined criterion, the predefined criterion being collectively achievable by the plurality of linked gaming machines, but not achievable by any one of the plurality of linked gaming machines; and

following satisfaction of the predefined criterion, performing a predetermined action.

The predefined criterion may comprise the occurrence of a combination of at least two different symbols, wherein each said game does not include at least one symbol in the combination.

The method may comprise repeating the process of comparing the identified outcomes with a predefined criteria and if one predefined criterion within the predefined criteria is satisfied, performing a said predetermined action, the predetermined action differing for at least two of the predefined criteria. The predetermined criteria may comprise criteria having different probabilities of occurrence. The predetermined action may involve the award of an award, wherein the value of the award relative to awards for other criteria reflects the difference in the probabilities of occurrence of the predefined criteria.

According to yet another aspect, the invention broadly resides in a method for use with a plurality of linked gaming machines, each gaming machine operable to play at least one game, the method comprising:

identifying a plurality of outcomes resulting from play of at least one game on each of at least two of a plurality of linked gaming machines;

comparing the identified outcomes with predefined criteria, the predefined criteria comprising at least two distinct criterion that are each collectively achievable by the plurality of linked gaming machines; and

following satisfaction of a said criterion, performing a predetermined action.

According to another aspect, the invention broadly resides in a method for use with a plurality of linked gaming machines, each gaming machine operable to play at least one game, the method comprising:

assigning distinct particular outcomes to at least two gaming machines in a plurality of linked gaming machines;

monitoring outcomes resulting from play of at least one game played using the linked gaming machines for occurrence of the particular outcome; and

following the occurrence of at least two distinct particular outcomes performing a predetermined action.

The process of assigning distinct particular outcomes to at least two gaming machines may comprise performing the assignment in an electronic data processing system in communication with each of the gaming machines and the process of monitoring the outcomes resulting from play of at least one game played using the linked gaming machines comprising communicating information indicative of the outcomes from the gaming machines to the electronic data processing system.

Alternatively, the process of assigning distinct particular outcomes to at least two gaming machines may comprise performing the assignment in each of the gaming machines and the process of monitoring the outcomes resulting from play of at least one game played using the linked gaming machines may comprise communicating information indicative of the occurrence of the particular outcomes during play of the game on a said gaming machine from that gaming machine to an electronic data processing system.

According to another aspect, the invention broadly resides in a method for use with a plurality of linked gaming machines, each gaming machine operable to play at least one game, the method comprising:

identifying a plurality of outcomes resulting from play of at least one game on each of at least two of a plurality of linked gaming machines;

comparing the identified outcomes with a predefined criterion for the outcomes, the predefined criterion comprising outcomes having a different probability of occurrence on different gaming machines and being collectively achievable by the plurality of linked gaming machines; and

following satisfaction of the predefined criterion, performing a predetermined action.

According to another aspect, the invention broadly resides in instructions executable by a game controller to implement the method as described in the immediately preceding paragraphs and to such instructions when stored in a storage medium readable by the game controller.

According to another aspect, the invention broadly resides in a gaming system comprising a plurality gaming machines, each gaming machine providing at least one game in which a plurality of symbols are selected and presented on a display and if a winning combination occurs in the selected symbols, the gaming machine awards an award, the gaming system comprising an electronic data processing system, which for each gaming machine:

identifies a plurality of outcomes resulting from play of the at least one game on each of at least two of the gaming machines;

compares the identified outcomes with a predefined criterion defined by information in electronic storage in communication with the electronic data processing system, the predefined criterion comprising the occurrence of at least two outcomes that are collectively achievable by the plurality of linked gaming machines; and

following satisfaction of the predefined criterion, causes the award of an award by at least one said gaming machine.

The electronic processing system may comprise an electronic data processing system in communication with a game controller for each of the plurality of gaming machines, wherein the gaming system includes a communication link between each gaming machine and the electronic data processing system over which information either identifying the outcomes resulting from play of the at least one game on that gaming machine, or identifying when an outcome that forms part of the predetermined criterion has occurred, is communicated from the gaming machine to the electronic data processing system, which determines when the criterion has been satisfied.

The predefined criterion defined in said electronic storage may comprise the occurrence of at least two distinct outcomes, which are achievable on mutually exclusive sets of gaming machines within the plurality of linked gaming machines.

The predefined criterion defined in said electronic storage may comprise outcomes having a different probability of occurrence on different gaming machines in the linked gaming machines.

The predetermined action may comprise the electronic processing system causing the award of an award at each gaming machine that contributed to the satisfaction of the criterion. The award may be equal for each said gaming machine. Alternatively, the award to each said gaming machine may be determined depending on what outcome of the criterion occurred in that gaming machine and/or the order in which the outcomes of the criterion occurred in the gaming machines.

In one embodiment, the predetermined action comprises the electronic data processing system causing the award of a common feature game at each gaming machine that contributed to the satisfaction of the criterion and the possible outcomes of the feature game may comprise outcomes associated with the award of another award at the gaming machine where the feature outcome occurred.

The predefined criterion may comprise the occurrence of a plurality of events that can occur at separate times and may specify that the plurality of events must occur within a certain proximity to each other to satisfy the criterion. In one embodiment, the plurality of events must occur within a certain period of time. In another embodiment, the plurality of events must occur within a certain number of game plays. In a still further embodiment, the plurality of events must occur within a certain amount of turnover on the linked gaming machines. The predetermined criterion may specify that the events must occur within a proximity dictated by the longest or shortest period defined by a plurality of metrics of proximity.

In one embodiment, if the predefined criterion comprises the occurrence of a plurality of events within a certain proximity to each other and the period defined by the certain proximity lapses from the first of the plurality of events without the predefined criterion having been met, then all of the predefined events that have occurred at the time of the lapsing of the period defined by the certain proximity are disregarded for determining whether the predefined criterion is satisfied after the time of the lapsing of the period defined by the certain proximity. In another embodiment, only the first occurring predefined event is disregarded and the period defined by the certain proximity is redefined with reference to the second occurring predefined event.

The electronic storage may contain information defining predefined criteria, wherein said predetermined action comprises a different action depending on which criterion in said criteria has been satisfied. The predefined criteria may have different probabilities of occurrence.

In a further aspect the present invention provides a gaming machine configured to run one or more client processes, at least one of which is configured cooperate with corresponding servers to trigger a second level event in accordance with the first aspect of the invention. In a further aspect of the present invention there is provided, application programs configured to cause a gaming machine and/or server to operate in accordance with the first aspect of the invention.

Further aspects of the present invention will become apparent from the following description, given by way of example only and with reference to the accompanying drawings.

### BRIEF DESCRIPTION OF THE DRAWINGS

Notwithstanding any other embodiments that may fall within the scope of the present invention, certain embodiments of the present invention will now be described, by way of example only, with reference to the accompanying figures, in which:

FIG. 1 depicts a network gaming system suitable for implementing an embodiment of the present invention;

FIG. 2 is a schematic perspective view of a gaming machine according to an embodiment of the present invention;

FIG. 3 shows a block diagram of gaming apparatus suitable for implementing an embodiment of the present invention;

FIG. 4 shows a block diagram of components of the memory of the gaming apparatus represented in FIG. 3;

FIG. 5 is a simplified schematic view of a gaming machine network illustrating the operation of an embodiment of the present invention;

FIG. 6 is a flow chart illustrating a process for triggering an event in an embodiment of the present invention;

FIG. 7 depicts a portion of a player interface rendered on a display of the gaming machine of FIG. 2, showing an accumulation of symbols in accordance with an embodiment of the present invention;

FIG. 8 depicts a second portion of a player interface rendered on a display of the gaming machine of FIG. 2 showing a message transmitted from one player to another by a player interaction service;

FIG. 9 depicts a portion of a further player interface rendered on a display of the gaming machine of FIG. 2, showing proposed division of a feature outcome between a group of cooperating players;

FIG. 10 depicts an equivalent portion of a player interface to that of FIG. 7 after a feature has been triggered; and

FIGS. 11a and 11b show a flow diagram of a process performed in accordance with an embodiment of the present invention.

### DETAILED DESCRIPTION

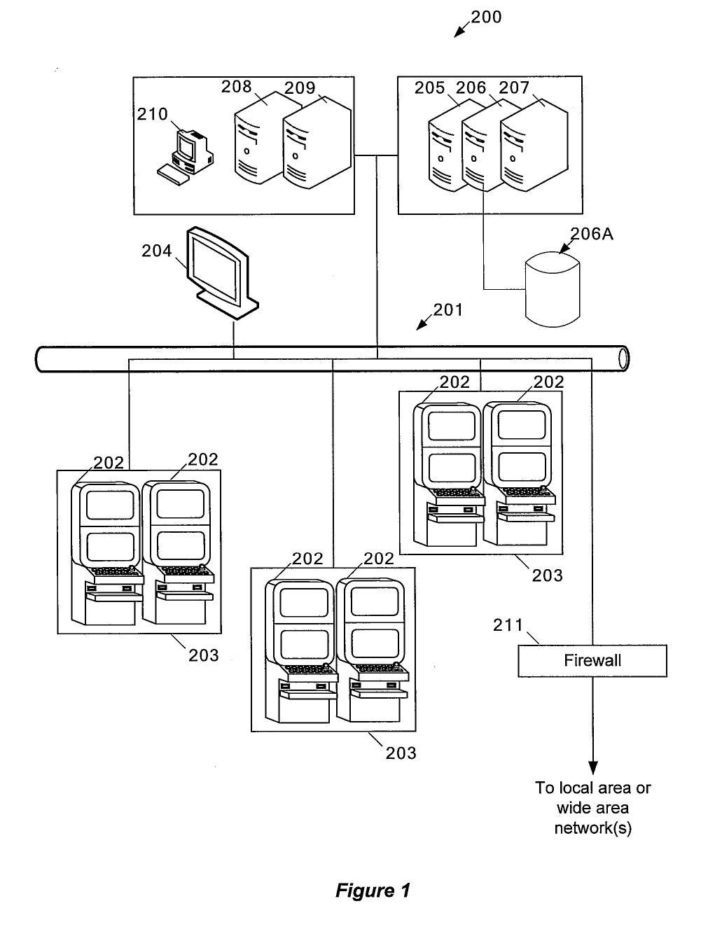

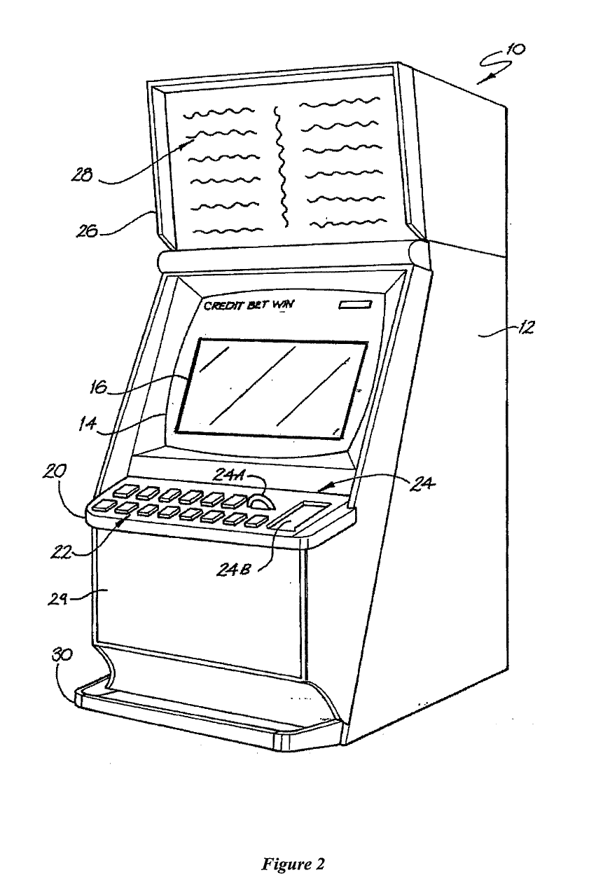

FIG. 1 shows a gaming system 200. The gaming system 200 includes a network 201, which for example may be an Ethernet network. Gaming devices 202, shown arranged in three banks 203 of two gaming devices 202 in FIG. 1, are connected to the network 201. The gaming devices 202 may be gaming machines 10, as shown in FIG. 2 or form part or all of another gaming apparatus 100. Single gaming devices 202 and banks 203 containing three or more gaming devices 202 may also be connected to the network 201.

One or more displays 204 may also be connected to the network 201. The displays 204 may, for example, be associated with a bank 203 of gaming devices. The displays 204 may be used to display representations associated with game play on the gaming devices 202, and/or used to display other representations, for example promotional or informational material.

Servers may also be connected to the network 201. For example, a game server 205 may generate game outcomes for games played on the gaming devices 202, a database management server 206 may store game programs and associated data in a database 206A so that they are available for downloading or access by the gaming devices 202 and a jackpot server 207 may control one or more jackpots associated with the gaming devices 202.

Further servers may be provided to assist in the administration of the gaming system 200, including for example a gaming floor management server 208, and a licensing server 209 to monitor the use of licenses to particular games. An administrator terminal 210 is provided to allow an administrator to run the network 201 and the devices connected to the network. The different servers depicted can be distinct physical servers or logically distinct server processes running on a single server.

The gaming system 200 may communicate with other gaming systems, other local networks, for example a corporate network and/or a wide area network such as the Internet through a firewall 211.

In FIG. 2 of the accompanying drawings, a gaming machine suitable for implementing an embodiment of the present invention is generally referenced by arrow 10.

The gaming machine 10 includes a console 12 having a display 14 on which is displayed representations of a game 16, that can be played by a player. A mid-trim 20 of the gaming machine 10 houses a bank of buttons 22 for enabling a player to play the game 16. The mid-trim 20 also houses a credit input mechanism 24 including a coin input chute 24A and a bill collector 24B. A top box 26 may carry artwork 28, including for example, pay tables and details of bonus awards and other information or images relating to the game. Further artwork and/or information may be provided on the front panel 29 of the console 12. A coin tray 30 is mounted beneath the console 12 for cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. In this latter respect, if the game 16 is a spinning reel game, the display 14 may use a stepper motor to control the position of physical reels. The top box 26 may also be a display, for example a video display unit, which may be the same type as the display 14, or a different type of display.

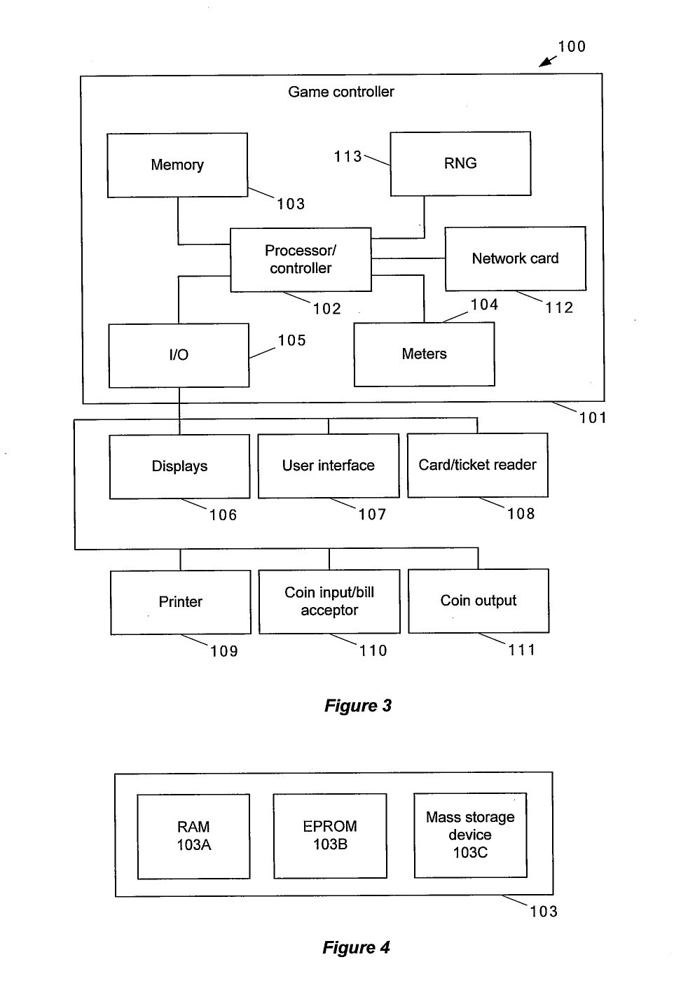

FIG. 3 shows a more detailed block diagram of the gaming apparatus 10 illustrated in FIG. 2. The gaming apparatus 100 includes a game controller 101, which in the illustrated example includes a microprocessor, microcontroller, programmable logic device or other computational device 102. Instructions and data to control operation of the computational device 102 are stored in a memory 103, which is in data communication with the computational device 102. Typically, the gaming apparatus 100 will include both volatile and non-volatile memory and more than one of each type of memory, with such memories being collectively represented by the memory 103. In addition, the computational device 102 may include two or more computational devices that each perform computational functions and which may be located locally or remotely from each other. The instructions to cause the game controller 101 to implement certain embodiments of the present invention will be stored in the memory 103.

In use the computational device 102 is configured to run one or more client process which interacts with a server (or server process) a gaming system to which the gaming apparatus 100 is connected, in order to implement a gaming function e.g. a game, a bonus game, jackpot or the like. The computational device 102 is further configured in the preferred embodiments to run at least one promotional client process which interacts with a promotions server (or server process) of the gaming system to enable a promotions function to be implemented in respect of the gaming machine or player thereof. As will become apparent additional client processes can also be run either permanently or from time-to-time on the computational device 102 to implement additional functions of the system.

The gaming apparatus may include meters 104 for the purposes of regulatory compliance and also include an input/output (I/O) interface 105 for communicating with the peripheral devices of the gaming apparatus 100. The input/output interface 105 and/or the peripheral devices may be intelligent devices with their own memory for instructions and data.

In the example shown in FIG. 3, the peripheral devices that communicate with the controller are one or more displays 106, user interfaces 107, a card and/or ticket reader 108, a printer 109, a bill acceptor and/or coin input mechanism 110 and a coin output mechanism 111. Additional devices may be included in the gaming apparatus 100 or devices omitted, for example. One or more of the peripheral devices may be an intelligent peripheral device, having its own memory containing instructions and data.

In addition, the gaming apparatus 100 also includes a communications interface, for example a network card 112 to communicate with the gaming network for such purposes as sending status information, accounting information and the like to a central controller, allowing communication from the central controller to the gaming apparatus 100 or for other purposes. In one embodiment, the functions of the computational device 102 may be split between a remote device and a local device, for example with game outcomes generated remotely and game graphics for the display 106 generated locally. In another embodiment, the peripheral devices only may be provided locally together with a network interface, in which case all, or nearly all intelligent devices may be located remotely of the display 106.

FIG. 4 shows a block diagram of the main components of the memory 103. The RAM 103A typically holds program files and data for execution by the computational controller 102. The EPROM 103B may be a boot ROM device and/or may contain some system or game related code. The mass storage device 103C is typically used to store game programs, the integrity of which may be verified and/or authenticated by the computational controller 102 using protected code from the EPROM 103B or elsewhere. Those skilled in the relevant arts will appreciate that alternative possibilities exist for the location of code and data.

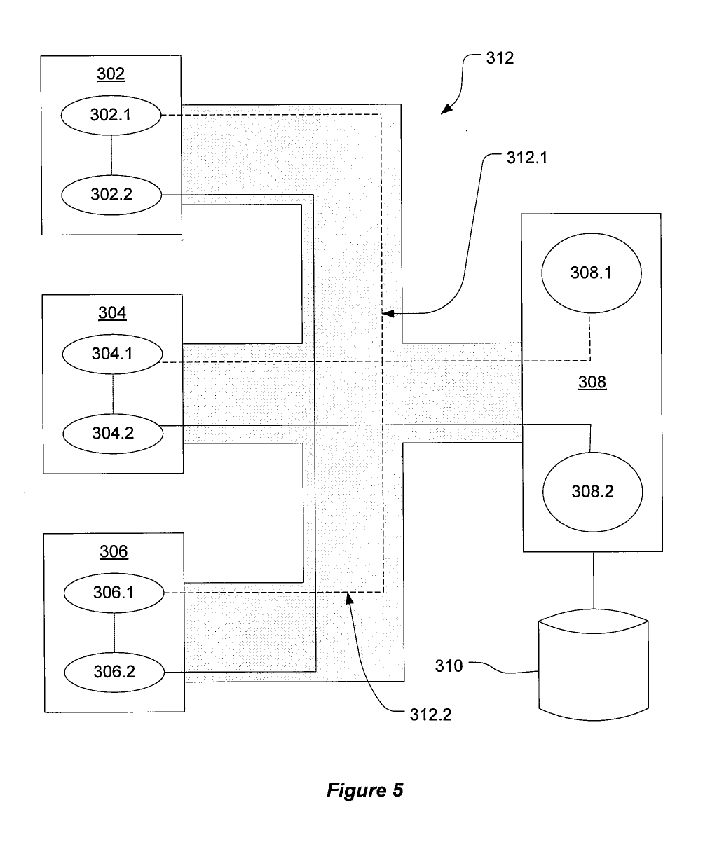

In order to more clearly explain the operation of the illustrative embodiments of the present invention, a simplified illustration of a gaming machine network is illustrated FIG. 5. FIG. 5 depicts a gaming system 300 including three gaming machines 302, 304, 306, a server system 308 and data storage means 310 which are communicatively interconnected via a communications network 312. As will be appreciated, there may be more or fewer gaming machines or servers systems included but for simplicity in illustrating embodiments of the present invention, only three gaming machines and a single server system is depicted.

Each gaming machine 302, 304, 306 runs an associated game client designated 302.1, 304.1, 306.1 respectively, and an associated promotional client designated 302.2, 304.2, 306.2, respectively. The game clients 302.1, 304.1, 306.1 are connected to the server system 308 and interact, via logical connections 312.1, with a game server process 308.1 (also called a game server) to enable a game to be played on the respective gaming machine 302, 304, 306. The promotions clients 302.2, 304.2, 306.2 interact, via logical connections 312.2, with a promotional server process 308.2 (also called a promotional server). The game and promotional servers 308.1 and 308.2 are also in data communications with the data storage 310.

In a preferred form, the system 300 operates in accordance with an embodiment of the invention disclosed in WO 2005/120672, entitled “Gaming System” which describes gaming systems having gaming machines having a plurality of client side processes that interact with corresponding servers to implement gaming features or services. Other methods of operation may also be used.

In an illustrative example to be described herein, the gaming machines 302 to 306 are arranged to play a spinning reel game. Clearly other embodiments may relate to different games types. As will be known to those skilled in the art, a spinning reel game is provided with actual or simulated reels which are adapted to spin (or simulate the effect of spinning) during game play. In order to begin a game a player makes a wager on the outcome of the game and selects a desired playing strategy (the amount wagered and the number of pay lines being activated) and initiates the game using the game control interface. Once the game is initiated the reels of game spin. Once the reels stop their positions determine (or reflect) the game outcome with reference to the game strategy played by the player. If the game outcome fulfils certain predetermined criteria a prize can be awarded to the player. In addition to any monetary payout or other winning award, associated with a particular outcome certain outcomes may be used as a triggering event which triggers the award of an accumulation token to the player (the first level event).

As will be described below, these accumulation tokens can be collected by a player, or combined with collections of tokens by other players, to trigger a bonus game feature.

In an exemplary embodiment, if a winning game outcome arises in which three symbols of the same kind are aligned on an active pay line (as determined by the players playing strategy) an accumulation token corresponding to the symbol is awarded to the player, e.g. if the following combination appears along an active pay line “10”, “10”, “Jack”, “2”, “10”, the player will be awarded an accumulation symbol corresponding to a “10”. As will be appreciated over the course of time a player may accrue several accumulation symbols of different (or the same) rank.

In order to trigger the bonus game (or other predetermined event) if the accumulation tokens accrued by a particular player meet a predetermined criterion, for example the player has accumulated five symbols of different ranks, e.g. “Ace”, “King”, “Queen”, “Jack” and “10”, this is considered a second level triggering event and a special feature is made available for playing by the player (or other second level event is triggered).

As will be appreciated, since a plurality of relatively rare first level triggering events must occur before the second level triggering event can occur. It will be extremely rare that a player will have the triggered feature made available to them. Therefore, in order to enable the second level feature to be played by more players, embodiments of the present invention provide a mechanism whereby players on different gaming machines on the network can pool their accumulated accumulation tokens such that the cooperatively accumulated pool of accumulation tokens fulfils the second level event triggering criteria.

In certain embodiments of the present invention, the triggering of a second level event is contingent upon the earlier triggering of two or more first level events. In some forms the two first level events are only able to be triggered on different ones (or groups of gaming machines). Thus the trigger of the second level event is conditional upon the earlier first level triggering events.

From a mathematical perspective events such as jackpots, features and wins are triggered according to the probability of an event occurring P(Ex).

But if events must be combined to trigger an event, conditional probability theory states:

P(E1 E2)=P(E1)×P(E2) for independent events.

Hence the magnitude of the probability of the single “second level” event can be determined by the probability of the two separate first level events (with higher magnitude of probability of occurring).

If the number of players playing linked gaming machines is equal to “n” and the players are able to generate one event within the allotted time “t”, then (n) events are generated.

If event 1 (i.e. one of the first level triggering events) has a probability of occurrence of P(E1), then the probability that the next event is the required Event 2 (i.e. another predetermined first level triggering events) is P(Ex)=P(E1)×P(E2).

The probability that any one of the players generates the required Event is

P(Ex)=(PE1)×(n−1)P(E2). Hence to generate two events with the equivalent probability of P(Ex) is P(Ex)=(n−1)×(PE1)×P(E2).

If we are to award an equal prize (for simplicity and fairness) then the participants must be required to generate a first level triggering event with equal probability, i.e. P(E1)=P(E2).

Hence the required probability of the events being generated by the players is proportional to the number of players and the required probability. The required probability for any two players to trigger the two required first level events (to cause a second level triggering event) from “n” total players is:
P(Ex)=(n−1)×(PE1)×P(E1).
P(E1)=Square root(P(Ex)/n−1).

In the case where the regulators require that the “Return to Player” is fair. The contribution of each possible win can be represented as the probability of the win and the award amount, as follows:
RTP(x)=P(Ex)×Award(x),
P(Ex)=RTP(x)/Award(x)
or
Award(x)=RTP(x)/P(Ex).

If we are substituting the conditional triggers for the general trigger, then the RTP contribution should be the same and hence:

RTP(x)=RTP(1)+RTP(2) when the second level event is triggered by two players.

The award to each player due to wins triggered by conditional probability is then:
RTP(x)=P(Ex)×Award(x)=P(E1)×Award(1)+P(E2)×Award(2)

Again, assuming fair and equal rewards:
P(Ex)×Award(x)=P(E1)×Award(1)+P(E1)×Award(1)
P(Ex)×Award(x)=2×P(E1)×Award(1).

The award to each player can therefore be determined as a function of the non conditional award, as follows:
Award(1)=Award(x)×P(Ex)/(2×P(E1)).

If we just want to get a feel for the magnitude of the relationship in a two player scenario where only two players are playing to trigger the second level award:
P(E1)=Square root(P(Ex))
Award(1)=Award(x)×P(Ex)/(2×Square root(P(Ex))).

So the award allocated to two players as a fraction of the traditional award is:
Award(1)/Award(x)=Square root(P(Ex))/2.

If one wants to determine the award as a function of the number of players:
Award(1)=Award(x)×(P(Ex)/(2×P(E1))
Award(1)=Award(x)×(n−1)×P(E1)ˆˆ2/(2×P(E1))
Award(1)=Award(x)×(n−1)×P(E1)/2.

So in a many player environment the following equations can be presented:
P(E1)=Square root [P(Ex)/n−1] Equation 1
Award(1)=Award(x)×(n−1)×P(E1)/2. Equation 2

These equations imply two concepts.

1) As the number of player attempting to achieve the condition increases, the probability of the event that they are attempting to achieve decreases. In other words the event becomes harder to achieve.

2) As the number of player attempting to achieve the condition increases, the amount awarded to the players increases.

A similar scenario arises when considering multiplayer cooperative triggers. In this case first level events, e.g. jackpots, features and wins are triggered according to the probability of an event occurring P(Ex). But conditional probability theory states:

P(E1 E2)=P(E1)×P(E2) for independent events, that is the probability of occurrence of a combined second event P(E1 E2) occurring is the product of the probabilities occurrence of it contributing first level events. Hence it is feasible that the magnitude of the probability of a single event can be determined by the probability of two consecutive separate events (with higher magnitude of probability).

If the number of players playing is equal to “n” and the players are able to generate one event within the allotted time “t”, then (n) events are generated.

Therefore if event 1 has a probability of occurrence of P(E1), then the probability that the next event is the required Events is
P(Ex)=P(E1)×P(E2) . . . P(Em).
The probability that any “m” of the “n” players generates the required Event is
P(Ex)=(PE1)×(n−1)P(E2)×(n−2)P(E3) . . . (n−m+1)P(Em).

If we are to award an equal prize to each contributor to the award of the combined prize (for simplicity) then the participants should generate an event with equal probability:
P(E1)=P(E2) . . . =P(Em).

It should be noted that (n−1)×(n−2)× . . . (n−m+1) is the number of permutations of n−1 objects taken m at a time and is denoted as n−1Pm.

The required probability for any “m” player from “n” total players to trigger an event is:
P(Ex)=n−1Pm×(PE1)ˆˆm.
P(E1)=[(P(Ex)/n−1Pm]ˆˆ1/m.

Again, in the scenario that the regulators require that the “Return to Player” is fair. The contribution of each possible win is represented as the probability of the win and the award amount.
RTP(x)=P(Ex)×Award(x)
P(Ex)=RTP(x)/Award(x)
or
Award(x)=RTP(x)/P(Ex).

Then if one substitutes the conditional triggers for the general trigger then the RTP contribution should be the same and hence for the general case where “m” players from “n” possible players achieve the trigger condition the:
RTP(x)=RTP(1)+RTP(2)+ . . . RTP(m).

In this case, the award to each player due to wins triggered by conditional probability is:
RTP(x)=P(Ex)×Award(x)=P(E1)×Award(1)+P(E2)×Award(2)+ . . . P(Em)×Award(m).

Again, assuming fair and equal rewards i.e. P(Ex)×Award(x)=m×P(E1)×Award(1).

Now determining the award to each player as a function of the non conditional award for the general case where “m” players from “n” possible players achieve the trigger condition the:
P(Ex)×Award(x)=m×P(E1)×Award(1)
Award(1)=Award(x)×P(Ex)/(m×P(E1)).

If one wants to determine the award as a function of the number of players:
Award(1)=Award(x)×P(Ex)/(m×P(E1))
Award(1)=Award(x)×n−1Pm×(PE1)ˆˆm/(m×P(E1))
Award(1)=Award(x)×n−1Pm×(PE1)ˆˆ(m−1)/m.

So in a many player environment:
P(E1)=[(P(Ex)/n−1Pm]ˆˆ1/m Equation 3
Award(1)=Award(x)×n−1Pm×(PE1)ˆˆ(m−1)/m. Equation 4

Therefore an award of a jackpot (or other second level event) can be made to two players as the result of two conditional wins, rather than by using a single less probable win as is traditional.

From the above equations the probability of triggering jackpots is known while the jackpots awards themselves are indeterminate until triggered. Hence the probability to be used in triggering the jackpot is now defined by Equation 1. In the two player case, the award should be half the jackpot for the two players that achieve the event at the defined probability.

Such a scheme can be applied to link jackpot arrangements, which in a traditional system are triggered by a particular pay. In contrast to this, in an embodiment if the present invention, where the jackpot is triggered by a combination of two players, the hit rate of the associated win combination should be calculated using Equation 1.

Similarly, in a Hyperlink™ jackpot arrangement where the jackpot is conventionally triggered by the players bet in relation to a relative range for the purpose of producing a particular probability, a cooperative hyperlink jackpot arrangement can be implemented in which the bets of two players should be used within ranges defined by the probability calculated using Equation 1.

A similar process can be applied to the award of features to two players as the result of two conditional wins rather than on the basis of a single less probable win.

When awarding features in such a scenario the probability to be used in triggering the feature is should be calculated as defined by Equation 1, and the award allocated to the two players by the feature so triggered is now defined by Equation 2.

In the above embodiments the consideration of two or more players can be handled in two separate ways. The first is that conditional probability as set forth above applies to more than two players. The second is that the third player needs to be involved in a conditional win with a fourth player within the time frame, i.e. the two player version is effectively repeated.

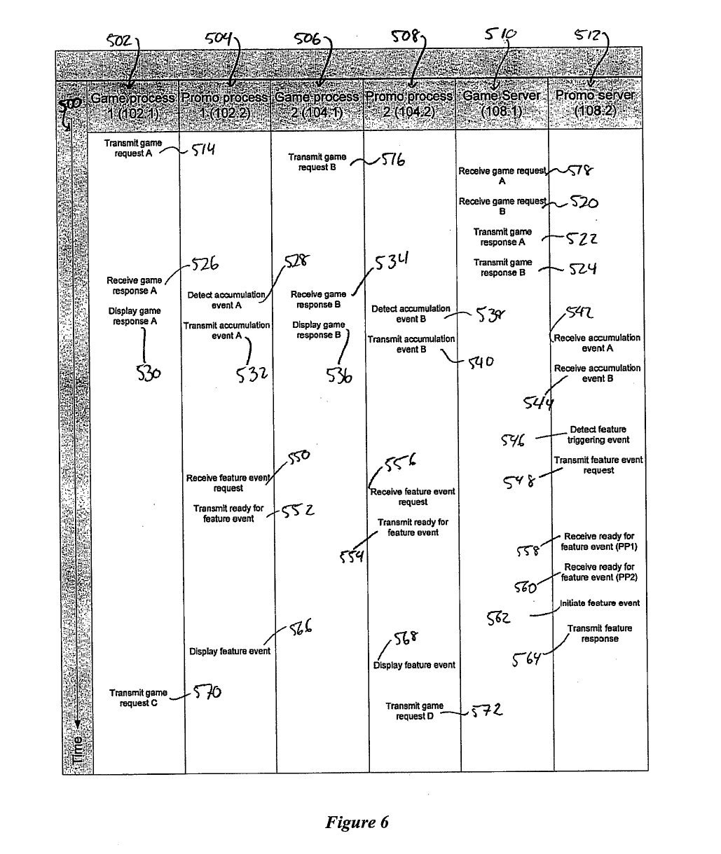

Further details of the mechanism for triggering a second level event, such as a bonus feature, by one or more players will now be described in connection with FIG. 6, which depicts a flow chart of interactions between a first game process and promotional process, a second game process and promotional process, a game server and promotional server. In the flow chart of FIG. 6 the left most column 500 includes a vertical arrow which represents the passage of time. The next column 502 represents the actions performed by a first game client process, e.g. process 302 of FIG. 1, while the next column 504 reflects the actions performed by an associated first promotional client process e.g. promotional client process 302.2 of FIG. 5. Similarly, columns 506 and 508 reflect the actions performed by a second game client process and an associated second promotional client process respectively, such as game client process 304.1 and promotional client process 304.2 of FIG. 5. The next column 510 reflects the actions of the game server configured to control the operation of a game played on the gaming machine with their respective associated game client processes. The game server in this example corresponds to the game server 308.1 of FIG. 5. The last column of the flow chart 512 reflects the actions performed by promotional server, such a promotional server 308.2 of FIG. 5, which is configured to control the operation of the promotional feature accessible to players of linked gaming machines.

At the beginning of the time period depicted in the flow chart of FIG. 6, each of the game process 302.1 and 304.1 are in a game mode in which they are able to communication with a game server 308.1 to enable a game to be played on the respective gaming machines. In the first step 514 the first game process 302.1 transmits game request to the game server 510. The game request will typically be issued by the game process in response to an action of a player, such as the insertion of a coin or the pressing of an appropriate button or touch-screen interface of the associated gaming machine. This first game request is received in step 518 by the game server 308.1 as illustrated. Similarly in a next step 516 the second game process 506 transmits a game request to the game server 308.1. The game request is received by the game server 308.1 at step 520.

In the next steps 522 and 524 the game server 308.1 transmits the first game response to game process 302.1 one and the second game response to game process 304.1. The game response is received by the first game process 302.1 at step 526. In the present example, the game played has resulted in an outcome which fulfils criteria for triggering a first level event. For example, as described above the game outcome might include a symbol combination on an active payline of a reel strip game, which fulfils a predetermined criterion for the award of an accumulatable token. The award of this accumulatable token is detected by the promotional process 302.2 in step 528. Next, the outcome of the game is displayed at step 530 by the game process 302.1. The promotional client process 302.2 then transmits the detected accumulation event (i.e. the award of an accumulation token) at step 532 to the promotional server 308.2. Similarly, the second game process 304.1 receives its corresponding game response in step 534 and displays the outcome in step 536. As with the first game process 302.1 the outcome of the second game, the game of process 304.1 is such that a first level triggering event occurs. Accordingly, the promotional client process 304.2 detects at step 538, the first level event e.g. the award of an accumulatable token to the player, and transmits this accumulation event at step 540 to the promotional server 308.2.

In steps 542 and 544 the promotional server 308.2 receives the accumulation events from the first and second promotional client processes respectively. In response to the first received accumulation event in step 542 the promotional server in step 546 compares the accumulatable tokens gathered by the first and second gaming machine to a predetermined triggering criterion and determines that the criterion is met. Next, in step 548 the promotional server process 308.2 transmits a feature event request to the promotional client processes 302.2 and 304.2. The feature event request is received by the promotional game client 302.2 in step 550. Because the player of the gaming machine associated with the first game client process 302.1 and has not initiated another game the first gaming machine is in a state in which the promotional feature can be run. In this case, in step 552 the promotional process 302.2 transmits a “ready for feature event” message back to the promotional server. Similarly, the second gaming machine is in a state in which a feature event can begin so that its promotional client process 304.2 issues, in step 554, a message indicating its readiness for the feature event, in response to the feature event request received in step 556. The two ready for feature event messages from each of the promotional client processes 302.2, 304.2 are received in steps 558 and 560 respectively. The promotional server 308.2 then initiates the feature event in step 562 and transmits the feature response or feature game outcome back to the promotional client processes 302.2 and 304.2 in step 564. The first and second promotional client processes 302.2, 304.2 display the promotional game outcome in steps 566 and 568 respectively.

Next in steps 570 and 572 the first game process 302.1 and the second game process 304.1 issue requests for new games to the game server 308.1 in response to an action performed by the player of respective gaming machines.

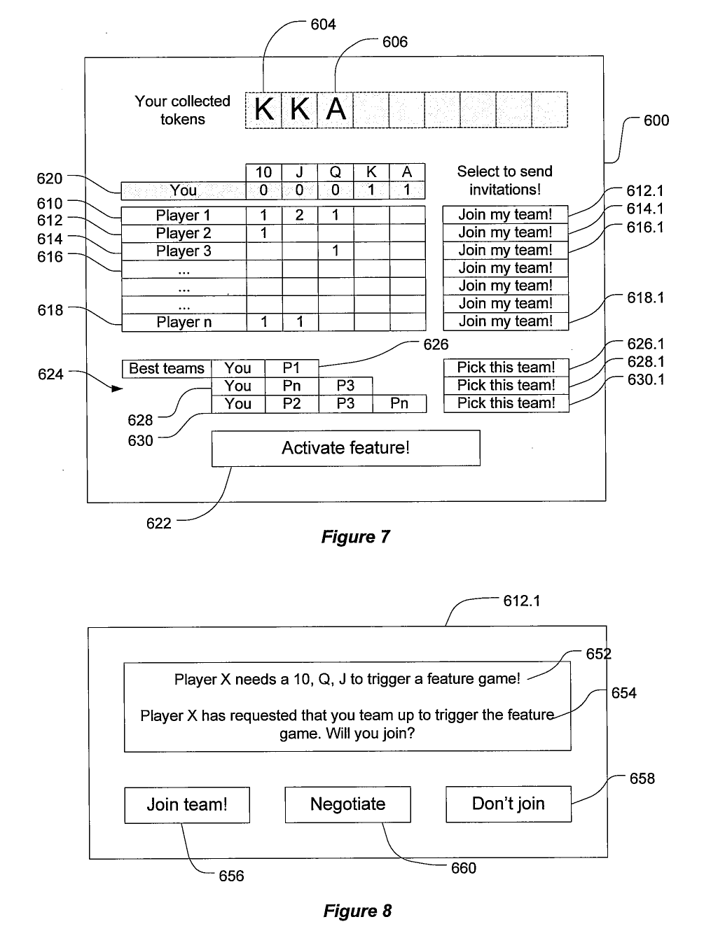

In order to better understand such a process from a player's point of view, FIGS. 7 to 10 depict a screen display, or a portion of a screen display illustrating an exemplary interface used in an embodiment of the present invention. Turning firstly to FIG. 7 which shows a portion of an interface 600 which will be used by the promotional client to indicate to a player referred to as Player X herein) their progress towards activation of a promotional feature. The interface 600 includes a series of regions 602 which are populated with symbols e.g. “King” symbol 604 and “Ace” symbol 606, indicating accumulation tokens previously awarded to a play by previously triggering a first level event. Each time the first level event occurs and a new accumulation symbol is awarded to a player a symbol representing the awarded token is added to the display 600 in one of the zones 602. As will be appreciated by viewing the symbols displayed in zones 602 the player of the gaming machine can determine the extent of which their accumulated tokens fulfil the predetermined criterion for triggering the feature.

As indicated above, in certain embodiments of the present invention, a player may cooperate with other players in order to active the feature. In the case where a player can choose to form an alliance with others, it is necessary to control this process. The following paragraphs set put some considerations that are made in implementing such a cooperative triggering system. In this description it will be useful to consider two types of players requesters—i.e. those who generate a request to form an alliance; and participators—those who join the requester. An alliance can have one requestor and multiple participators. It should be understood that in certain embodiments the alliance might be formed prior to triggering a feature, and the purpose of the alliance may to team up to activate the feature.

In the basic case, when a requester is seeking an alliance the participator (or participators) are selected of a “first come, first served basis”. In this case, such as when a broadcast request is made, the requestor has no say in who plays. If the identities of the participants in the game would possibly make a difference to the outcome of the game, then the requestor can be given the chance to select the other participators.

In order to maximise a player's winnings it is advantageous to minimise the number of participants that join a team. In this case a default condition can be set so that if any one player or minimal combination of players best satisfies the needs of the requestor (i.e. combine to cause a feature or other event to be triggered) then the minimal combination of players is chosen. If several combinations exist the participators are accepted for participation on a “first come, first served” basis.

In the event that the trigger conditions to be achieved to trigger a feature do not have the same probability of occurring the, a scheme may need to be applied to equitably distribute winnings. In this regard, it is preferable that if the outcome of the multiplayer game results in a prize to be distributed, then the portions of the prize delivered to the participants can be based on the relative probabilities of their contribution to the triggering event occurring.

If the triggering event of interest requires the accumulation of a predetermined number of tokens and the total tokens of requestor and participator is greater than that required to trigger the feature it is preferable that the requestor uses all of his/her tokens, while the participator only enough of his tokens to trigger the feature.

In some embodiments the player may be offered an option to direct the system to prioritise any friends that respond to the request. Such a feature is particularly useful if the requestor has friends within the possible respondents.

A problem can arise if two requesters make requests and there are enough eligible participators to form a single alliance, but because either one or both of the requestor's select one or more participators (e.g. their friends), the remaining pool of possible participators is too small to make either alliance. In this case it is advantageous that the first request gets priority over the second. The system may also highlight the conflict to the players and ask the second (or first) requestor to the cancel their request. If the neither cancel their request the conflict will be resolved through first in first served.

Returning now to FIG. 6, the interface 600 is provided with a table 610 which indicates the number and/or type of accumulation symbols collected by one or more players of other gaming machines, with whom the player may team up to trigger the feature in order to assist a player in forming alliances. In the table 610, each horizontal row represents the current number of each type of accumulation token collected by the players of other gaming machines. As can be seen in row 612, Player 1 has one “10” accumulation token, two “Jack” accumulation tokens and a single “Queen” accumulation token. This player has no “King” or “Ace” tokens at the present time. Rows 614 and 616 indicate the number of accumulation tokens of each kind held by Players 2 and 3 respectively. Similarly row 618 indicates that Player n has one “10” accumulation token and one “Jack” accumulation token. In order to assist Player X using interface 600 to determine whether he or she may team up with one or more of the other players to active the feature, the Player X's own accumulation token holdings are illustrated in the same format, as the other players in row 620. If the Player X wishes to request one or more of other players to pool their accumulation tokens to trigger the feature, Player X may select the join-my-team button e.g. 612.1, 614.1, 616.1 or 618.1, corresponding to their desired team mate, or team mates. Once team mates are selected, Player X selects the activate feature button 622 and a request to join his or her team will be sent to each of the selected players. In order to assist the player in selecting an appropriate team, a segment of the interface 600 may be dedicated to suggested team groupings such as indicated at 624. In this portion 624 of the display 600, suggested team groupings are listed e.g. a first team comprising the current player and Player 1 at 626, the second team comprising the current player as well as Player n and Player 3 at 628 and the third team the current player and Players 2 and 3 and the Player n at 630. Each of the suggested teams has a corresponding button labelled “Pick this team!” 626.1, 628.1, 630.1 which enables the player to select all of his/her team mates by a single selection.

In the event that a player of a gaming machine is selected by another player to team with them to trigger the feature, that player will be given the opportunity to either join the team or refuse to join the team. An interface enabling a player to receive a request to join a team and to accept or decline the request is depicted in FIG. 8. In FIG. 8 the interface 650 includes first text region 652 setting out that Player X, the requesting player, requires certain symbols in order to trigger the feature. In a following text block 654 the player is requested to team up with player X to activate the feature. The request to join a team to trigger the feature will only be made if the requesting player has identified a team of players which has sufficient accumulation tokens to fulfil the criteria for triggering the feature.

If the player viewing interface 650 wishes to join the team they select button 656. If he or she does not wish to join the team they select button 658. If the player wishes to negotiate the nature of their co-operation, e.g. by negotiating which symbols they are willing to pool with the player, or to negotiate a particular division of any winnings awarded by the feature, the “Negotiate” button 660 is selected.

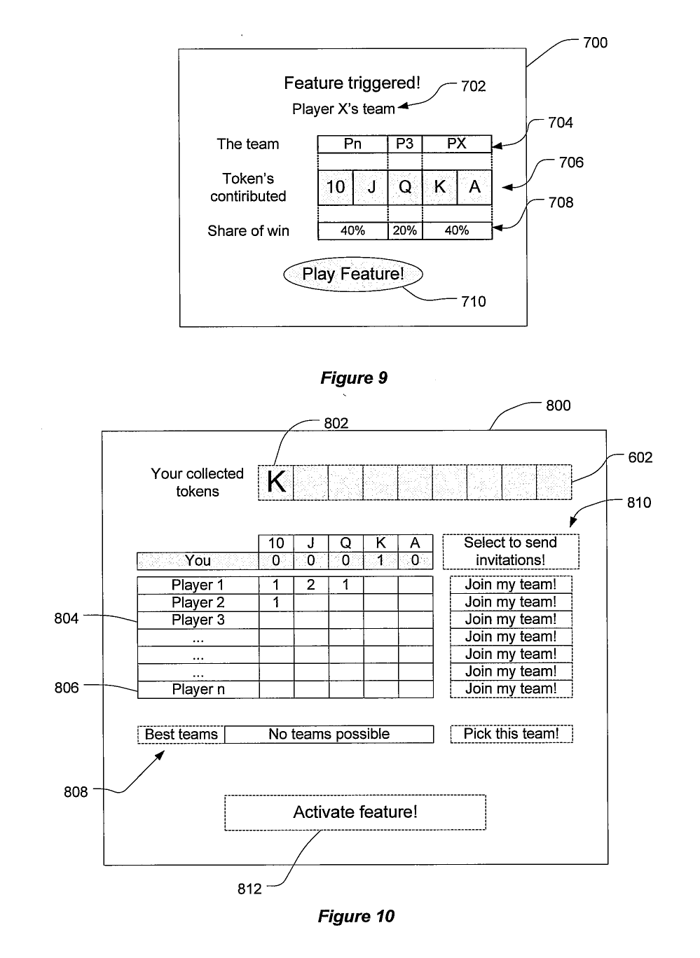

Once one or more of the requested players have joined with the requesting player to form a team to trigger the feature, a display such as that of FIG. 9 will be displayed to each of the participants including the requesting player.

In FIG. 9 a portion of an interface 700 is shown which identifies each of the players who have cooperated to trigger the feature. In this case player X is identified at 702 as the requestor and each of the participators, Player n, Player 3 and Player X, are listed as team members at 704. The tokens contributed by each of the players are also shown at 706. As can be seen in the present example Player X has contributed “King” and “Ace” symbols, Player 3 has contributed a “Queen” symbol and Player n has contributed the “10” and “Jack” symbols. At 708 the percentage share of any winning outcome in the feature is depicted for the information of team members. In the illustrated example, if there are any winnings from the feature they will be split proportionally to the level of contribution each player made to triggering the feature, that is, Player X provided 40 percent of the accumulated tokens needed to trigger the feature and accordingly will receive 40 percent of any winning outcome from the feature. Similarly Player n will receive 40 percent, and player 3 will receive 20 percent of any winning outcome. As mentioned above if players wish they may choose to negotiate different proportions for sharing any winning payouts from the bonus feature.

Player X can then select the play feature button 710 of the interface to initiate the game feature. As will be appreciated, a play feature button 710 may not be needed on the interface seen by Players n and 3 in, which case this button can either omitted from their interface or made inactive.

In one embodiment, the handling of the communication between players, e.g. in the set-up phase and negation phase could be handled by the promotional client and server or dedicated communication processes. An example of a suitable player to player communication architecture that may be applied in an embodiment of the present invention is described in our co-pending United States complete patent application which was filed on the same day as the present application and entitled “Gaming system” and which claims priority from Australian Provisional application, no. 2006902577 in the name of Aristocrat Technologies Australia Pty Ltd, the contents of which are herein incorporated by reference.

The promotional client process associated with Player X's gaming machine then notifies the promotional server process that the feature is to played and await further data from the server process in relation to this. In certain embodiments the promotional server will provide the results of the feature outcome to the promotional client for display to the players. Typically, the playing of the feature game will be shown to each of the participating players either in a primary or secondary display of the gaming machine or in a window in part of the gaming machine display.

Once the game outcome has been determined and if the winning outcome occurred, prizes can be awarded to each of the participating players and their normal game play can resume.

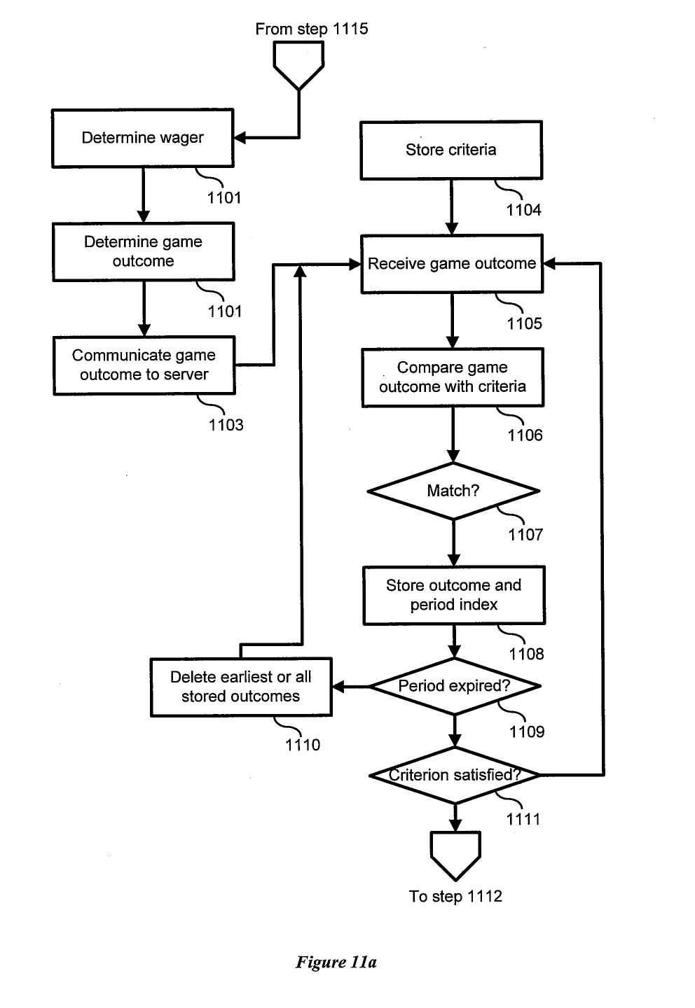

As will be appreciated once a player has used his/her accumulated tokens these will be removed from their “bank” of accumulated tokens. FIG. 10 depicts an equivalent to display to that of FIG. 7 for Player X after participation in a feature. For convenience features common to FIGS. 10 and 7 have been numbered in a corresponding fashion and only points of difference will be discussed. As can be seen Player X now only has one “King” accumulation symbol 802 rather than previously having two “Kings” and an “Ace” as shown in FIG. 7 because he/she used those two symbols to trigger the feature, as discussed above. Player n and Player 3 have used all of their tokens as indicated at 804 and 806. Because the Player X no longer has sufficient accumulated tokens alone, or in combination with any other group of players, no possible teams are listed 808 and the buttons to invite players at 810 are inactive. Similarly the “Activate feature” button has been made inactive to indicate that the feature is not able to be activated by the player at the present time.

The opportunity to negotiate may be presented as a phase immediately prior to the initiation of the second level event. In this case, the second level event will not be initiated until the negotiation process has been completed. In one embodiment, completion of the negotiation process is indicated by one or more of the players operating an “agree” button or control (not shown) or touch pad region (not shown) of the screen display.

Alternatively, the opportunity to negotiate may be presented as part of the process of determining which of the players will join a team to trigger the second level event.

With regard to the negotiation process itself, in one embodiment, a numeric keypad can be provided to enable players to enter proposals such as a proposed percentage apportionment of winnings from the second level event. For example, this may be a simple process of each player entering proposed percentages for that player and also for other players until an agreement is reached. In this embodiment, each gaming machine must be configured for each player to indicate acceptance or refusal of percentage proposals made by other players and/or to submit alternative proposals.

Alternatively, a list of negotiation options may be generated and presented to the players on a screen display. In this case the players can select which option they prefer, and if the players select the same option, the negotiation process is deemed to have been successfully concluded.

In certain embodiments, the requesting procedure can operate in a different order to that described above, for example, the requestor can simply ask players, directly or via broadcast, via the system if the y want to cooperate, and then they make an offer as to the terms of their cooperation, e.g. the number and type of tokens being offered, and/or the percentage payout they want in order to cooperate. The requestor can then compare all responses and accept those that he or she chooses, thus completing and triggering the second level event if the selected team fulfils the second level event triggering criterion (or criteria).

Also the bonus or feature game, if one is awarded as part of the second level event, may be played by a player other than the requester, e.g. the person who contributed the most to triggering the game, a person nominated by the players or randomly (or otherwise) selected by the system.

If the second level event is a game feature it may be displayed on a secondary screen, or a portion of the screen, to enable regular game play to continue on a primary screen or screen window.

The first level trigger event need not be a determined from a game outcome, as in the examples described above, but can be another type of event. Take the following examples. The outcome of a bonus game may be used as the first level trigger e.g. a particular type of bonus game out come may trigger the first level event or the bonus award may be the biggest bonus award made that hour in the casino.

An outcome of a tournament game may be used, for example, in the same way as a standard game outcome or in relative terms, e.g. based on the margin of a tournament outcome. A first level triggering event may be based on a player's status or other criterion, e.g., all of a casino's VIP customers currently playing a gaming machine at a particular time, or the player may need to have played a certain number of games to cause a first level trigger.

Similarly a gaming machine itself may fulfil a gaming machine-related criterion to trigger the event, e.g. the machine might have had its 10000^{th} game played which causes the first level event trigger.

Other network nodes might fulfil a criterion can cause a first level event to be triggered in respect of one or more machines or players, e.g. a player tracking node on the network (not shown) may detect the first 100 players into the casino in the morning and trigger a first level event for each.

To increase excitement the system, game or jackpot software may trigger first level events for players at random.

The first level event can include, associating or awarding at least one accumulatable token with a gaming machine or player of a gaming machine. Said token is preferably represented in a data form, but may include an associated monetary or other prize or an item e.g. a ticket or coupon, exchangeable for a monetary or other prize.

The second level event can be selected from a wide range of events, and need not be the playing of game or bonus feature. For example the second level event triggered could be the award of a prize, say a dinner or tickets to a show, a bonus payout or entry into a draw for a prize. It may result in the award of an immediate bonus payout rather than the playing of a special or bonus game feature.

As will be appreciated when an embodiment of the present invention is implemented using an architecture of the type disclosed in WO 2005/120672, each of the entities, e.g. game, machine, jackpot or player or the like can be represented in the system as a respective process, or combination of client/server processes.

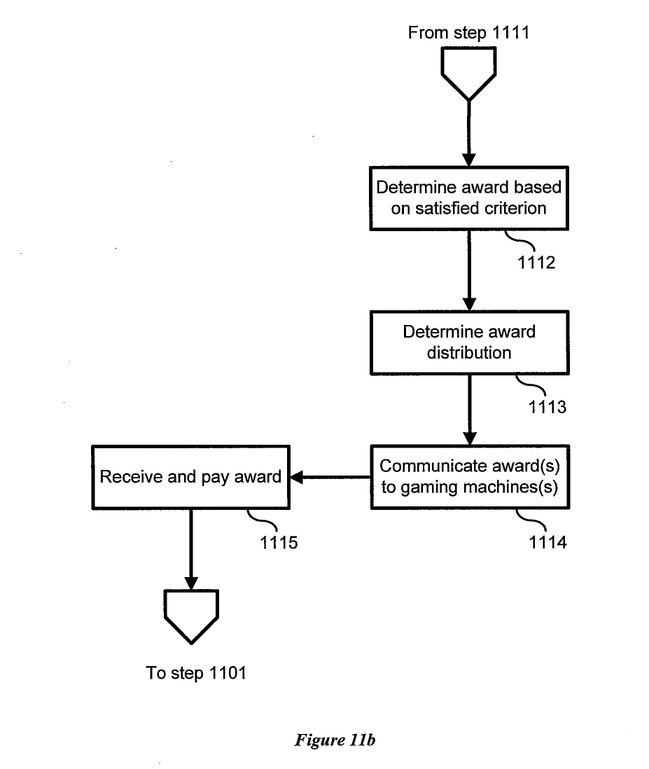

FIGS. 11a and 11b shows a process flow diagram of a process able to be used to implement additional embodiments of the present invention. As with the earlier embodiments the process may be performed by the gaming system 200, in which the gaming consoles 202 each include game controllers 101 to form gaming machines 100 and the following description assumes this implementation. However, the process will also be able to be implemented by other gaming systems.

In step 1101, the game controller 101 monitors the bill acceptor and/or coin input 110 and/or information received by the card/ticket reader 108 or network card 112 for a deposit of credit and in response causes the hardware meters 104 to increment according to the denomination of the game. The game controller 101 then monitors the bank of buttons/touch screen 107 for the input of a wager.

If there are sufficient credits in the meters 104 to support the wager, a game play is commenced in step 1102 by the game controller 101 determining the game outcomes to result from the game, based on numbers from the RNG 113. The displays 106 display representations of the outcome of the game and any award is awarded to the player as a result of the game. The game may be any game of chance playable on a gaming machine, for example, a spinning reel game, a poker style card game, or a dice game. The game may also include one or more second screen feature games provided in a manner well known in the relevant art.

In step 1103 the game controller 101 then uses its network card 112 to communicate the game result over the network infrastructure 201 to a server that manages the prize awarding process. This server may be the jackpot server 207.

In step 1104 of FIG. 11A, the jackpot server 207 stores the criteria for the prize awarding event. The criteria may be entered by an administrator of the gaming system 200, for example using a terminal such as the administrator terminal 210. The criteria may be fixed, or may be variable. For example, the gaming venue has a promotion in which one additional criteria are added with associated prizes and/or the existing criteria may be associated with larger prizes. The jackpot server 207 may only be active at all during certain periods of time.

In another embodiment, the criteria may be varied depending on the number of gaming machines 100 currently being played in the gaming system 200, for example changing the criteria to pay lower value prizes more frequently in terms of game play when a number of gaming machines 100 being played is below a certain threshold. In another embodiment, the jackpot server 207 may operate to offer the prizes only during certain periods of play of the gaming machines 100. For example, eligibility to attempt to satisfy the criteria may be dependent on a trigger event occurring on a gaming machine or within the gaming system 200. Various suitable trigger events are known, including symbol-based trigger events and events based on the turnover of the gaming machines.

The jackpot server 207 receives the game outcomes (step 1105) and compares them with the criteria (step 1106).

A criterion includes a plurality of game outcomes, so that a plurality of game outcomes must be received before the criterion can be satisfied. In one embodiment, the game outcomes may be defined so that no single gaming machine can achieve all of the game outcomes required to satisfy a criterion in the criteria. In step 1107, the jackpot server 207 determines whether the game outcome matches a required outcome in a criterion. If not, the process returns to step 1105 and the jackpot server 207 awaits receipt of a further game outcome. If there is a match, the outcome is stored in electronic storage together with a period index. In the terminology used in relation to the description of the previous embodiments, the matching of the criterion can be viewed as a first level triggering event, and the writing of the event to storage (or the associated payout on the base game outcome—should one be awarded) can be viewed as a the first level event. The period index may be a time index based on the time of receipt of the game outcome, or may be otherwise determined. An alternative period index may be a counter initialised to 0, the counter counting each received game outcome in step 1105. A further alternative period index may be based on the turnover or coin-in of the gaming machines 100.

The jackpot server 207 also stores in electronic storage as part of the criteria a maximum period. For example, the maximum period may be a time of 10 minutes, or 1000 game plays, or whichever expires earlier or later. Different maximum periods may be defined for different criteria. If the period has expired, then in step 1110, the jackpot server 207 deletes either the earliest stored outcome or all of the stored outcomes, depending on the specific implementation. Those skilled in the relevant arts will appreciate that the outcome need not necessarily be deleted, merely not considered for future determination of whether that criterion has been satisfied.

If the period has not expired, then the process proceeds from step 1109 to step 1111, in which the jackpot server 207 determines whether any criterion from the criteria has been satisfied. If not, then the process returns to step 1105, if a criterion has been satisfied then the process proceeds to step 1112 and the jackpot server 207 determines the award to be awarded. Again in the terminology used above, the fulfilment of the second criteria by stored outcomes can be seen as a second level triggering event, and the award of the award is the second level event.

Where there is only one criterion in the criteria, then the award will always be the same. In embodiments where there are multiple award winning events, then the jackpot server 207 may look up a pay table to determine the award.

The evaluation of the outcomes for satisfaction of part of a criterion may be performed by the jackpot server 207 as described above, or alternatively within the gaming machine 100, for example by the game controller 101 according to instructions held in memory 103. If the evaluation is performed within the gaming machine 100, then the gaming machine 100 need only communicate to the jackpot server 200 when part of a criterion has been achieved on that gaming machine 100, instead of communicating every outcome to the jackpot server 200 for evaluation.

In step 1113, the jackpot server 207 determines how the award is to be distributed. Distribution of the award may be limited to the gaming consoles 202 that communicated outcomes to the jackpot server 207 to satisfy the criterion. The award may be divided equally between the consoles 202 or may be unevenly distributed, for example having regard to the order of occurrence of the outcomes that each gaming console 202 achieved to satisfy the criterion and/or the probability of occurrence of the outcome, which may apply where multiple machines can achieve the same outcome, but with different probabilities.

Once the award value and distribution have been determined, at step 1114 the jackpot server 207 communicates information defining the award to the relevant gaming consoles 202. The gaming machines 100 then pay the applicable award (step 1115). The process then returns to step 1101.

In one embodiment using the method of FIGS. 11a and 11b, one or more groups of gaming machines 100 within a gaming venue may be predefined as participating to win the prizes administered by the jackpot server 207. In this embodiment, it may be advantageous if every gaming machine can achieve the outcomes required to win an award administered by the jackpot server 207, so that the absence of a player at one or some of the gaming machines 100 in the group does not mean that the prizes can not be won. Alternatively, ‘dummy’ gaming machines 100 that are not being played may be treated as if they are being played, with game outcomes generated at a certain rate, which may be fixed, or may depend on the rate of play of the gaming machines 100 that are being played.

In one embodiment using the method of FIGS. 11a and 11b, gaming machines 100 may be dynamically formed into groups according to which gaming machines 100 are currently being played. If there are insufficient gaming machines 100 to form an integer number of complete groups, then one or more ‘dummy’ gaming machines 100 may be added to complete the last group. The groups may change over time as players start and stop playing certain gaming machines 100. The groups may also change over time as players change games on gaming machines 100 that are capable of playing multiple games, for example by downloading a game from the database management server 206, or by selecting another game stored in memory 103.

If the gaming machines 100 are dynamically formed into groups, then it is possible for multiple groups to be attempting to achieve the same criterion. In this embodiment, each gaming machine that achieves the same symbol in a criterion is allocated to a separate group. The timer or counter for the group will start when the first gaming machine 100 forms a group.

Alternatively, the gaming system 200 may operate so that there is only one active group for each criterion at a time. The groups may be defined on a first to achieve the required outcomes basis, so that after one gaming machine 100 achieves an outcome that is required as part of a criterion, other gaming machines 100 achieving the same outcome do not qualify for the prize for that criterion. When the time period for the first gaming machine 100 to achieve the outcome expires, or when the criterion is satisfied, then other gaming machines 100 may qualify for the prize by achieving the same outcome.

The gaming machines 100 in a group may all be located within the gaming system 200, or may be partly located in the gaming system 200 and partly located in one or more other gaming systems 200, which are communicably connected to the gaming system 200.

### EXAMPLE 1

Six spinning reel gaming machines 100 form a bank 203 of consoles 202 and each gaming machine 100 is connected to the jackpot server 207. Each gaming machine 100 has a special symbol on the reels. All bet amounts entitle the player to be eligible to play for the jackpot prizes administered by the jackpot server 207. Alternatively an ante-bet or a certain sized bet may be required before a gaming machine 100 is eligible to participate in attempting to satisfy a criterion of the jackpot server 207.
Machine 1 has a Red Star;
Machine 2 has a Blue Star;
Machine 3 has a White Star;
Machine 4 has a Red Bar;
Machine 5 has a Blue Bar; and
Machine 6 has a White bar.

The prizes that are able to be caused to be awarded by the jackpot server 207 and the combinations that result in award of the prizes are:
Red Star, White Star, Blue Star, Red Bar, White Bar and Blue Bar, which pays 2,000 credits;
Red Star, White Star, and Blue Star, which pays 500 credits;
Red Bar, White Bar and Blue Bar, which pays 500 credits;
Red Star and Red Bar, which pays 100 credits;
Blue Star and Blue Bar, which pays 100 credits; and
White Star and White Bar, which pays 100 credits.

The prizes are paid to each gaming machine 100 that caused the combination to be achieved. For example if gaming machines 3 and 6 achieve the combination of White Star and White Bar, each pays 100 credits.

In this embodiment not all of the criterion are achievable by all of the gaming machines 100. For example the combination of White Star and White Bar can not be achieved by gaming machines 1, 2, 4 or 5. However, gaming machines 1 and 4 can achieve the combination of Red Star and Red Bar and gaming machines 2 and 5 can achieve the combination of Blue Star and Blue Bar. In this example the gaming machines are of the same denomination and the three combinations of like coloured Stars and Bars occur with the same average frequency, so that they all pay the same prize of 100 credits. This is not essential however, and variations in prize value can reflect variations in the average turnover or coin-in required to achieve the criterion.

When players are playing the machines, each time a game is played, the gaming machine 100 sends a message to the jackpot server 207 that the game has been played. If a special symbol appears on a purchased pay line, the machine also sends a message to the jackpot server 207 and the jackpot server 207 sends a message to the display 204 that the symbol has occurred on the gaming machine 100. The display 204 shows the symbols which have occurred. The display 204 may be located proximate to gaming machines 100 that are predetermined as participating in trying to meet a criterion, for example located above the gaming machines 100, which may be located in a bank 203. The jackpot server 207 may also or instead send a message to the six gaming machines 100, which may display on their display 106B the symbols that have occurred. The information on the display 106B may indicate whether that particular gaming machine has contributed a symbol to the symbols that have occurred. The displays 204 and/or 106B may display a timer or counter indicating how close the contributing machines are to the deadline for satisfying a criterion that has been partly satisfied.

The symbols which have occurred remain displayed on the display 204 and/or display 106B for a limited period. For example, the limited period can be 10 minutes or 1000 games (counted over all the machines), whichever is the least. In an alternative example, the limited period may be defined by whichever is the greatest. The limited period commences from the occurrence of the first special symbol.

When the game play of the six gaming machines 100 is such that display 204 and/or display 106B will show a prize winning combination, then the jackpot server 207 sends a message reporting the prize winning event to the machines 100 and a prize is awarded according to the payouts defined previously and the accumulated symbols used to define the prize are cleared. If the winning combination is not won within the limited period, then all the symbols are removed from the screen.

In an alternative embodiment, the symbols for each gaming machine 100 are time limited. Each symbol that occurs that forms part of a winning combination for the jackpot server 207 remains displayed on the display 204 and/or display 106B for 10 minutes or until 150 games are played on that machine, whichever is the least (or greatest in an alternative embodiment).

### EXAMPLE 2

Five card gaming machines 100 form a bank 203 of consoles 202. Each gaming machine 100 is connected to the jackpot server 207. Each gaming machine 100 assigned a special symbol by the jackpot server 207:
Machine 1 is allocated the special symbol of Ace;
Machine 2 is allocated the special symbol of King;
Machine 3 is allocated the special symbol of Queen;
Machine 4 is allocated the special symbol of Jack; and
Machine 5 is allocated the special symbol of 10.

Special prizes are defined for special symbols as follows:
A K Q J 10 pays 2000;
4 of AKQJ or 10 pays 400; and
3 of AKQJ or 10 pays 100.

When each machine is played, it sends a signal to the jackpot server 207 that a game has been completed, which allows the jackpot server 207 and if a special symbol has been dealt, then a signal is sent to the jackpot server 207 that the symbol has occurred.

The jackpot server 207 sends a message to the display 204 and/or display 106B and the players can see that a special symbol has occurred. When the display 204 and/or display 106B shows a prize winning combination, then the jackpot server 207 sends a message to the gaming machines 100 and the applicable prize is awarded at each gaming machine 100.

### EXAMPLE 3

Five gaming machines 100 form a bank 203 of consoles 202 and each gaming machine 100 is connected to the jackpot server 207.

Each gaming machine 100 has a special symbol which can be found during a feature game, which is a game triggered during play of a base game on a gaming machine 100. The special symbols are defined as:
Machine 1 a golf ball;
Machine 2 a golf bag;
Machine 3 a golf club;
Machine 4 a golf flag; and
Machine 5 a golf shoe.

The prizes are defined as
5 unique golf items pays a jackpot;
Any 4 of the golf items pays 500; and
Any 3 of the golf items pays 100.

The jackpot may be a progressive prize, which is incremented upon each game play of a base game played on each gaming machine.

Each machine sends a message to the jackpot server 207 when a feature game is being played. The jackpot server 207 then erases the special symbol which has previously been displayed from that machine.

When a special symbol is revealed in the feature game, the gaming machine 100 sends the information to the jackpot server 207 and the special symbol is displayed on the display 204 and/or display 106B. If the special symbol is not revealed, then the display indicates a blank for that special symbol.

When the display shows a prize winning combination, then the jackpot server 207 sends a message to the gaming machines 100 contributing to the combination and a prize is awarded at each gaming machine 100.

### EXAMPLE 4

Ten gaming machines 100 are connected to the jackpot server 207. The games can be spinning reel, keno, bingo, card or ball games. There is no need for the games to be of a similar type.

When a trigger event occurs, the jackpot server 207 advises each gaming machine 100 that a feature game relating to a prize administered by the jackpot server 207 is in play. Each gaming machine 100 then displays a screen with only one large spinning reel. The player is requested to hit a particular button in the bank of buttons 107A and the large reel spins and slows down to reveal a symbol. The symbol shown on the reel determines the prize. Each feature game involves one or more, for example five spins of the reel.

The five examples described above all allocate single special symbols to each gaming machine. However, the outcome required could instead be defined by a combination of symbols in a game played on the gaming machines.

In an alternative embodiment, prizes awarded when a criterion is satisfied may be determined by the wager per outcome that was played on the gaming machine 100. For example if the game was a spinning reel game having pay lines and the player wagered two credits on the pay line that achieved a special symbol that contributed to the satisfaction of a criterion, then the prize awarded may be doubled.

Where in the foregoing description reference has been made to integers having known equivalents, then those equivalents are hereby incorporated herein as if individually set forth.

While the foregoing description has been provided by way of example of certain embodiments of the present invention as presently contemplated, which utilise gaming apparatus and machines, those skilled in the relevant arts will appreciate that the present invention also may have application to internet gaming and/or have application to gaming over a telecommunications network, where handsets are used to display game outcomes and receive player inputs.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of triggering an event in a gaming machine network including a plurality of gaming machines, said method including:
defining at least one first level trigger event which can be associated with at least one of said plurality of gaming machines; and in the event that a first level trigger event occurs,
triggering a first level event in relation to each associated gaming machine;
defining a second level triggering event which is dependent upon the occurrence of a plurality of first level events, each of said plurality of first level events being associated with one or more of said plurality of gaming machines; and in the event that said second level triggering event occurs,
triggering said second level event.

2. The method as claimed in claim 1 wherein at least two of the plurality of first level events are be associated with at least one different gaming machine.

3. The method as claimed in claim 1 wherein the first level trigger event is selected from the following kinds of event:
an outcome of a base game fulfilling at least one predetermined criterion;
an outcome of a bonus game fulfilling at least one predetermined criterion;
an outcome of a tournament game fulfilling at least one predetermined criterion;
at least one player fulfilling at least one player-related criterion;
a gaming machine fulfilling at least one gaming machine-related criterion;
a node of the network fulfilling at least one predetermined criterion;
an at least partly randomly generated event; and
a jackpot triggering event.

4. A method as claimed in claim 1 wherein the at least two of the first level triggering events on which a second level triggering event is dependent are achievable on mutually exclusive sets of gaming machines within the plurality of gaming machines.

5. A method as claimed in claim 1 wherein at least two of the first level triggering events on which a second level triggering event is dependent have different probabilities of occurrence on different gaming machines within the plurality of gaming machines.

6. A method as claimed in claim 1 wherein the first level event includes, associating or awarding at least one accumulatable token with a gaming machine or player of a gaming machine.

7. A method as claimed in claim 1 wherein the second level event trigger includes, compiling a plurality of accumulatable tokens that fulfil at least one predetermined criterion.

8. A method as claimed in claim 1 wherein the method further includes, enabling cooperation between players of two or more gaming machines, via the gaming machine network, to cause second level triggering event.

9. A method as claimed in claim 7 wherein a compilation of accumulatable tokens that fulfil at least one predetermined criterion include tokens associated with different gaming machines or players by corresponding first level events.

10. A method as claimed in claim 1 wherein the method further includes:
triggering a second level event in respect of at least two gaming machines or players.

11. A method as claimed in claim 10 wherein the second level event is triggered in respect of at least two players that have cooperated to cause the second level triggering event, or their associated gaming machines.

12. A method as claimed in claim 1 wherein the method further includes awarding a prize or award associated with said second level event to a plurality of players or gaming machines associated with said second level event.

13. A method as claimed in claim 12 wherein the method further includes, awarding a prize or award associated with said second level event to a plurality of players that cooperated to cause the second level triggering event, or their associated gaming machines.

14. A method as claimed in claim 1 wherein the method further includes, dividing a prize or award associated with said second level event amongst a plurality of players or gaming machines associated with said second level event.

15. A method as claimed in claim 1 wherein the method further includes, dividing a prize or award associated with said second level event according to any one of the following ways:
the prize or award associated with said second level event can be divided evenly amongst the plurality of players or gaming machines;
the prize or award associated with said second level event can be divided amongst the plurality of players or gaming machines in proportion to an extent of each player's or gaming machine's contribution to the second level triggering event;
the prize or award associated with said second level event can be divided amongst the plurality of players or gaming machines according to a player determined scheme;
the prize or award associated with said second level event can be divided amongst the plurality of players or gaming machines in proportion to the relative probability of occurrence of each player's contribution to the second level triggering event; and
the prize or award associated with said second level event can be divided amongst the plurality of players or gaming machines in proportion to an amount wagered by each player.

16. A gaming machine network including, a plurality of gaming machines, a plurality of first client processes each of which is configured to implement a gaming service associated with a respective gaming machine, a plurality of promotional clients each of which is configured to interact with an associated first client process to detect the occurrence of a first level event in the associated first client process; at least one promotional server process configured to interact with a plurality of promotional clients to determine the occurrence of a second level triggering event whose occurrence is contingent on the previous occurrence of a plurality of first level events; and in the event of a second level triggering event occurring triggering a second level event to be implemented by at least one of said promotional clients.

17. A gaming machine network as claimed in claim 16 wherein the second level triggering event determined by the promotional server process can be contingent upon the occurrence of at least one first level event in client processes associated with different gaming machines.

18. A gaming machine network as claimed in claim 16 wherein the first client process is selected from the following kinds of process:
a game process;
a bonus process;
a tournament game process;
a jackpot process
a player process a gaming machine process;
a system process.

19. A gaming machine network as claimed in claim 16 wherein the first level event is triggered by a first level triggering event selected from the following kinds of event:
an outcome of a base game fulfilling at least one predetermined criterion;
an outcome of a bonus game fulfilling at least one predetermined criterion;
an outcome of a tournament game fulfilling at least one predetermined criterion;
at least one player fulfilling at least one player-related criterion;
a gaming machine fulfilling at least one gaming machine-related criterion;
a node of the network fulfilling at least one predetermined criterion;
an at least partly randomly generated event; and
a jackpot triggering event.

20. A gaming machine network as claimed in claim 16 wherein the first level event includes the association of at least one accumulatable token with a gaming machine or player of a gaming machine by an associated first client process.

21. A gaming machine network as claimed in claim 16 wherein the promotional client process is configured to compile a plurality of accumulatable tokens associated with a respective gaming machine.

22. A gaming machine network as claimed in claim 16 wherein the promotional server process is configured to interact with a plurality of promotional clients and to compile a plurality of accumulatable tokens associated with different gaming machines, and wherein a second level triggering event is determined to have occurred if the plurality of accumulatable tokens compiled by the promotional server fulfil at least one predetermined criterion.

23. A gaming machine network as claimed in claim 20 wherein the network includes a plurality of player interaction processes configured to enable interaction between a player of a gaming machine associated with a player interaction process and at least one other gaming machine.

24. A gaming machine network as claimed in claim 16 wherein the promotional server process is configured to trigger two or more promotional client process to initiate a second level event in respect of two or more corresponding players that have cooperated to cause the second level triggering event, or their associated gaming machines.

25. A gaming machine network as claimed in claim 16 wherein the gaming machine network is configured to award a prize or award associated with said second level event to a plurality of players associated with said second level event in the event of at least one predetermined outcome.

26. A gaming machine network as claimed in claim 25 to wherein the network is configured so as to divide a prize or award associated with said second level event amongst a plurality of players in accordance with any one of the following ways:
the prize or award associated with said second level event can be divided evenly amongst the plurality of players or gaming machines;
the prize or award associated with said second level event can be divided amongst the plurality of players or gaming machines in proportion to an extent of each player's or gaming machine's contribution to the second level triggering event;
the prize or award associated with said second level event can be divided amongst the plurality of players or gaming machines according to a player determined scheme;
the prize or award associated with said second level event can be divided amongst the plurality of players or gaming machines in proportion to the relative probability of occurrence of each player's contribution to the second level triggering event; and
the prize or award associated with said second level event can be divided amongst the plurality of players or gaming machines in proportion to an amount wagered by each player.

27. A method for use with a plurality of linked gaming machines, each gaming machine operable to play at least one game, the method comprising:
identifying a plurality of outcomes resulting from play of at least one game on each of at least two of a plurality of linked gaming machines;
comparing the identified outcomes with a predefined criterion, the predefined criterion being collectively achievable by the plurality of linked gaming machines; and
following satisfaction of the predefined criterion, performing a predetermined action.

28. A method as claimed in claim 27 wherein the predefined criterion is the occurrence of at least two distinct outcomes, which are achievable on mutually exclusive sets of gaming machines within the plurality of linked gaming machines.

29. A method as claimed in claim 27 wherein the predefined criterion may comprise the occurrence of at least two outcomes having different probabilities of occurrence on different gaming machines within the plurality of linked gaming machines.

30. A method as claimed in claim 27 wherein the predetermined action comprises causing the award of an award at each gaming machine that contributed to the satisfaction of the criterion.

31. A method as claimed in claim 27 wherein the award is divided amongst said gaming machines, in one of the following manners:
the award is equal for each said gaming machine;
the award to each said gaming machine is determined depending on what aspect of the criterion was satisfied by that gaming machine;
the award to each said gaming machine is determined on the basis of the probability of the gaming machine satisfying the aspect of the criterion that was satisfied by that gaming machine.

32. A method as claimed in claim 27 wherein the predefined criterion comprises the occurrence of a plurality of events that can occur at separate times, and comprises a requirement that the plurality of events must occur within a certain proximity to each other to satisfy the criterion.

33. A method as claimed in claim 32 wherein the proximity of the plurality of events must occur within is determined on the basis of at least one of the following proximity metrics:
a certain period of time;
a certain number of game plays;
a certain amount of turnover on the linked gaming machines; and
a certain amount of coin-in on the linked gaming machines

34. A method as claimed in claim 32 wherein the predefined criterion comprises the occurrence of a plurality of events within a certain proximity to each other and the period defined by the certain proximity lapses from the first of the plurality of events without the predefined criterion having been met, then all of the predefined events that have occurred at the time of the lapsing of the period defined by the certain proximity are disregarded for determining whether the predefined criterion is satisfied after the time of the lapsing of the period defined by the certain proximity.

35. A method as claimed in claim 32 wherein, the predefined criterion comprises the occurrence of a plurality of events within a certain proximity to each other and the period defined by the certain proximity lapses from the first of the plurality of events without the predefined criterion having been met, then and the first occurring predefined event is disregarded and the period defined by the certain proximity is redefined with reference to the second occurring predefined event.

36. A method as claimed in claim 27 wherein the method comprises comparing the identified outcomes with predefined criteria, wherein said predetermined action comprises a different action depending in which criterion in said criteria has been satisfied.

37. A method as claimed in claim 26 wherein the predefined criteria have different probabilities of occurrence.

38. A method for use with a plurality of linked gaming machines, each gaming machine operable to play at least one game, the method comprising:
identifying a plurality of outcomes resulting from play of at least one game on each of at least two of a plurality of linked gaming machines;
comparing the identified outcomes with a predefined criterion, the predefined criterion being collectively achievable by the plurality of linked gaming machines, but not achievable by any one of the plurality of linked gaming machines; and
following satisfaction of the predefined criterion, performing a predetermined action.

39. A method as claimed in claim 38, wherein the predefined criterion comprises the occurrence of a combination of at least two different symbols, wherein each said game does not include at least one symbol in the combination.

40. A method as claimed in claim 38 wherein the method comprises repeating the process of comparing the identified outcomes with a predefined criteria and if one predefined criterion within the predefined criteria is satisfied, performing a said predetermined action, the predetermined action differing for at least two of the predefined criteria.

41. A method as claimed in claim 40 wherein the predetermined criteria comprise criteria having different probabilities of occurrence.

42. A method as claimed in claim 41 wherein the predetermined action involves the award of an award, in which the value of the award relative to awards for other criteria reflects the difference in the probabilities of occurrence of the predefined criteria.

43. A method as claimed in claim 38 wherein the predefined criteria comprise at least two distinct criterion.

44. A method for use with a plurality of linked gaming machines, each gaming machine operable to play at least one game, the method comprising:
assigning distinct particular outcomes to at least two gaming machines in a plurality of linked gaming machines;
monitoring outcomes resulting from play of at least one game played using the linked gaming machines for occurrence of the particular outcome; and
following the occurrence of at least two distinct particular outcomes performing a predetermined action.

45. A method as claimed in claim 44 wherein the process of assigning distinct particular outcomes to at least two gaming machines comprises performing the assignment in an electronic data processing system in communication with each of the gaming machines and the process of monitoring the outcomes resulting from play of at least one game played using the linked gaming machines comprising communicating information indicative of the outcomes from the gaming machines to the electronic data processing system.

46. A method as claimed in claim 44 wherein, the process of assigning distinct particular outcomes to at least two gaming machines comprises performing the assignment in each of the gaming machines and the process of monitoring the outcomes resulting from play of at least one game played using the linked gaming machines may comprise communicating information indicative of the occurrence of the particular outcomes during play of the game on a said gaming machine from that gaming machine to an electronic data processing system.

47. A gaming system comprising a plurality gaming machines, each gaming machine providing at least one game in which a plurality of symbols are selected and presented on a display and if a winning combination occurs in the selected symbols, the gaming machine awards an award, the gaming system comprising an electronic data processing system, which for each gaming machine:
identifies a plurality of outcomes resulting from play of the at least one game on each of at least two of the gaming machines;
compares the identified outcomes with a predefined criterion defined by information in electronic storage in communication with the electronic data processing system, the predefined criterion comprising the occurrence of at least two outcomes that are collectively achievable by the plurality of linked gaming machines; and
following satisfaction of the predefined criterion, causes the award of an award by at least one said gaming machine.

48. A gaming system as claimed in claim 47 wherein the electronic processing system comprises an electronic data processing system in communication with a game controller for each of the plurality of gaming machines, and wherein the gaming system includes a communication link between each gaming machine and the electronic data processing system over which information identifying either the outcomes resulting from play of the at least one game on that gaming machine, or when an outcome that forms part of the predetermined criterion has occurred, is communicated from the gaming machine to the electronic data processing system, which determines when the criterion has been satisfied.

49. A gaming system as claimed in claim 47 wherein the predefined criterion defined in said electronic storage comprises the occurrence of at least two distinct outcomes, which are achievable on mutually exclusive sets of gaming machines within the plurality of linked gaming machines.

50. A gaming system as claimed in claim 47 wherein the predefined criterion defined in said electronic storage may comprise outcomes having a different probability of occurrence on different gaming machines in the linked gaming machines.

51. A gaming system as claimed in claim 47 wherein the predetermined action may comprise the electronic processing system causing the award of an award at each gaming machine that contributed to the satisfaction of the criterion.

52. A gaming system as claimed in claim 51 wherein the award can be made according to any one of the following allocations:
the awards are equal for each said gaming machine;
the award to each said gaming machine are determined depending on what outcome of the criterion occurred in that gaming machine
the award to each said gaming machine are determined depending on an order in which the outcomes of the criterion occurred in the gaming machines;
the award to each said gaming machine are determined depending on the probability of each machine achieving the outcome that it contributed to the satisfaction of the criteria.

53. A gaming machine configured to run one or more client processes, at least one of which is configured cooperate with corresponding servers to trigger a second level event in accordance with a method as claimed in claim 1.

54. A set of computer readable instructions executable by a game controller of a gaming machine or a server system to implement the method as claimed in claim 1.

55. A data storage medium carrying a set of computer readable instructions as claimed in claim 54.
